(19) United States
(12) Patent Application Publication
(10) Pub. No.: US 2006/0175309 A1
(43) Pub. Date: Aug. 10, 2006

(54) Laser beam welding method

(75) Inventor: Wolfgang Danzer, Dorfen (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 10/544,457

(22) PCT Filed: Jan. 29, 2004
(86) PCT No.: PCT/EP04/00804

§ 371 Date: Jan. 10, 2006

(30) Foreign Application Priority Data
Feb. 4, 2003 (DE) 10304473.6

(51) Int. Cl. B23K 26/20; B23K 26/14

(52) U.S. Cl. 219/121.64; 219/121.84

(57) ABSTRACT

A method for laser welding by a fiber laser, according to which a process gas containing helium is directed to the processing point.

This application claims the priority of German patent document 103 04 473.6 filed Feb. 4, 2003 (PCT International Application No. PCT/EP2004/00804, filed Jan. 29, 2004), the disclosure of which is expressly incorporated by reference herein.

### BACKGROUND AND SUMMARY OF THE INVENTION

The invention relates to a method for laser beam welding using a fiber laser, whereby a laser beam created by the fiber laser is focused on a location to be machined or in the vicinity of a location to be machined.

The properties of the laser radiation, in particular the intensity and good focusability, have resulted in lasers being used today in many fields of machining materials. Laser machining systems are known per se. They usually have a laser machining head, optionally with a nozzle arranged coaxially with the laser beam. Laser machining systems are frequently used in combination with a CNC control unit. Lasers have always been used extensively in welding, because laser welding offers a more targeted heat input, lower deformation and a higher welding speed in comparison with conventional welding methods (MAG, TIG). Most laser welding does not require the use of filler material. However, this may be necessary in order to bridge a gap or for the metallurgy. Laser welding can be used with almost all materials such as steels, light metals and thermoplastics.

A focused laser beam is understood within the scope of this invention to refer to a laser beam focused essentially on the workpiece surface. In addition to the most widely used method with the laser beam focused on the workpiece surface, this invention may also be used with the less common variant in which the laser beam is not focused exactly on the workpiece surface.

The latest developments in laser technology have opened the possibility of using fiber lasers in laser welding. The fiber lasers are a completely new generation of lasers. Fiber lasers differ fundamentally in their properties from the CO₂ lasers, the Nd:YAG lasers and the diode lasers used in the past. The highest laser powers are achieved with CO₂ lasers. The laser power of the fiber laser is comparable to the laser power of the CO₂ laser and the Nd:YAG laser (the diode laser is characterized by a much lower laser power and therefore behaves significantly differently in laser welding than the high power lasers) and currently amounts to a few hundred watts. The wavelength of the fiber laser is in the range of 1060 nm to 1080 nm because rare earths such as ytterbium are used as the active medium, which is thus comparable to the wavelength of the Nd:YAG laser. However, the significant difference lies in the divergence of the laser beam, the focus diameter, the focus length or the beam parameter product. Of these parameters, the beam parameter product is the parameter, which is defined by the laser and determines the properties of the laser to a significant extent. The beam parameter product is a constant quantity which depends on the laser design. It cannot be altered by optical components (lenses or mirrors). The beam parameter product is defined as the product of the beam radius in the waist and half the divergence angle (far-field beam angle) as beam parameters and is given in units of mm″ mrad. Consequently, the beam parameter product is a measure of the focusability of a laser beam. The smaller the beam parameter product of a laser, the smaller is the area on which a laser beam can be focused. Beam parameter products for high power lasers are typically between 3 and 30 mm″ mrad. With the newly developed fiber lasers, beam parameter products of less than 1.6 mm″ mrad have now been achieved, even less than 1.4 mm″ mrad. With a beam diameter of 80 μm, a beam parameter product of less than 1.6 mm″ mrad would mean a divergence of less than 40 mrad. If the power of the fiber laser is 700 watts, for example, then a power density of more than 50 MW/cm² is achieved at a machining point. The focus at the machining point is approximately 40 μm in this example. The focus length of the fiber laser is approximately 150 mm. This means that the high power density is retained over a path length of 150 mm and consequently can be found not only on the surface of the workpiece but also in the workpiece or beyond the workpiece (in the case of workpieces with a thickness less than or equal to 1.5 cm). The reason for the high power density at the machining site is thus to be found in the excellent focusability of the fiber laser, which is specified by means of the beam parameter product. In comparison with that, the power density at the machining site for the high power lasers conventional in the past is at most in the range of a few MW/cm² and the focus is in the range of mm. The power density at the machining site has been multiplied as a result of the introduction of the fiber laser. For example, the company IPG Photonics offers fiber lasers with laser powers of 300 W to 700 W and beam parameter products of less than 0.7-1.4 mm″ mrad; these fiber lasers have a focus diameter of less than 30 μm to 50 μm at the machining site and a focus length of 150 mm. The fiber lasers may be operated either in pulsed or continuous operation.

In laser beam welding with high power lasers, material is vaporized and/or ionized at the machining site and moved away from the workpiece in the direction of the laser. At the machining site a vapor capillary is created in the material. Through this vapor capillary, the laser energy goes deep into the material. Therefore, thinner welds can be produced much more rapidly than would be possible through thermal conduction of the solid material from the surface into the depth of the material. In creating this vapor capillary, also known as a keyhole, very hot vaporized material that is actually ionized at higher laser powers, flows toward the laser beam. The plasma material interacts with the laser beam and influences it thereby. If the optical density of the metal vapor or metal plasma is too high, the laser radiation may no longer reach the workpiece and the welding process becomes ineffective or even collapses. Absorption of the laser radiation occurs mainly due to thermally ionized plasma. Formation of a plasma is especially problematical at high laser powers and here also leads to the failure of the welding process. If the required energy density is not available, then only the metal vapor absorbs. The resulting loss of laser power may reduce the welding speed by many times 10% but does not usually result in termination of the welding process. Since the laser power of Nd:YAG lasers is generally lower than the laser power of a CO₂ laser, it is often possible to omit the process gas in welding with Nd:YAG lasers. A process gas is usually used at high laser energies. It is customary now to not only control the plasma through the choice of the process gas but also to protect the material from harmful effects of the ambient air.

With the fiber laser, a different behavior is now manifested with respect to the vapor capillary. Because of the high power density at the machining site and the very small focus diameter, the result is a very fine vapor capillary of vaporized material and plasma. In addition, since the focus length is very long, the diameter of the vapor capillary is unchanged over a wide range. Since the diameter of the vapor capillary is proportional to the focus diameter, the diameter of a vapor capillary produced by a fiber laser is many times smaller than the diameter of a vapor capillary produced with a traditional high power laser. It is very difficult for vapor and plasma to escape from this very fine and long capillary. Consequently, a very dense plasma is formed in the capillary, and the laser beam can penetrate through it only with great difficulty. Because of the narrowness of the very long capillary, the behavior of the plasma and the vapor differs significantly from the behavior of a plasma formed by using the high power lasers customary in the past. However, when using a fiber laser so that high-quality laser welds are produced, the plasma and the vapor must be controllable.

A number of problems occur in laser welding with fiber lasers and it is extremely difficult to produce a high-quality weld. The problems differ greatly from the problems encountered in using the high power lasers customary in the past. These problems can be attributed to the high power density at the machining site in combination with the great focus length of the fiber laser. In particular, the properties of the vapor capillary must be influenced and the plasma and vapor must be controlled.

Therefore, the present invention is based on the object of providing a method which permits high-quality laser welding using a fiber laser.

This object is achieved according to this invention by directing a process gas containing helium at the machining site. Since the process gas surrounds the weld, the latter is protected from the environment. An important disadvantage of ambient air—in addition to the aggressive components—is the humidity present in the air because it promotes the formation of pores that reduce quality. It is therefore important for the process gas to be free of impurities accordingly. Since helium is an inert gas, the machining site is protected from the environment by helium. In addition, the properties of the material can be influenced in a targeted manner at the weld through the choice of components of the process gas. However, deciding factors include the influence of the process gas on the welding operation and the effects of the process gas on the quality of the weld. If the process gas stream envelopes the laser beam directly and uniformly from all sides, a targeted influence on the welding process is possible in a particularly advantageous manner because the interaction of the process gas with the material and the laser beam is especially pronounced. It has surprisingly now been found that with a process gas containing helium, the plasma formation can be controlled even in the very narrow vapor capillaries that extend without any widening and are produced in this form only by a fiber laser. The deciding factors here are both the ability of helium to control and restrict the formation of the plasma as well as the property of helium of being a very small and light gas which is easily vaporized. The first property of plasma control mentioned above is based on the difficulty in ionizing helium and the increased laser beam permeability of the plasma and the vapor. The second property mentioned above is the one that solves the special problems that occur when using a fiber laser. Owing to the easy volatility of helium, a process gas containing helium also goes deep into the very narrow vapor capillaries. Helium is also characterized in that it spreads out uniformly in the capillary and does not tend to collect at certain locations or in direct contact with material. This makes it possible to control the plasma over the entire area of the vapor capillary. Only through this control which extends from the surface deep into the workpiece can advantages of the fiber laser be utilized comprehensively. Without effective control of the plasma into the depth of the workpiece, the high power density can be utilized only at the surface of the material, whereas material removed spatially from the surface must be melted by thermal conduction. High welding speeds are consequently possible only with the method according to this invention because this ensures that the laser beam can penetrate deep into the material and the material will vaporize directly. Since the fiber laser has a very great focus length, the high power density is also available in the interior of the material and vaporization of the material is particularly effective. In addition, the development of pores is also suppressed by the inventive method. Since the laser radiation can penetrate into the material when using a process gas containing helium and a capillary with homogeneous properties is formed due to the uniform distribution of helium, the condition [sic; conditions] are comparable over the entire depth of the capillary, and material is vaporized everywhere. There are no irregularities due to vapor bubbles occurring suddenly or differences in vaporization of the material. This is extremely effective in suppressing the development of pores. It is therefore possible with the inventive method to manufacture high-quality welds at high welding speeds.

### DETAILED DESCRIPTION

In an advantageous embodiment of this invention, the process gas that is used contains 10 vol % to 90 vol % helium, preferably 20 vol % to 70 vol % helium, especially preferably 30 vol % to 50 vol % helium. The advantages of the inventive method are manifested in these volume ranges. The amount of helium to be selected depends on the quality to be achieved, the welding speed, the material and economic considerations.

Argon is advantageously present in the process gas. Argon does not facilitate control of the plasma in the vapor capillary but instead is inert and thus suppresses harmful effects from the environment. However, since this gas is much less expensive, it is often advantageous to replace some of the helium with argon. Instead of the preferred argon, other inert gases, such as noble gases may be used as components of the process gas. If nitrogen is inert with respect to the material to be welded, then helium may also be replaced by nitrogen. Occasionally it is also advantageous to add a mixture of inert gases.

In an advantageous embodiment of this invention, an active gas is contained in the process gas. By adding active gases to the process gas, the properties of the weld and the material of the workpiece in the immediate vicinity of the weld are influenced. Through the active gases, the structure of the material in the vicinity of the weld can be influenced in a targeted manner and chemical and physical reactions take place at the surface. In addition, there is an energy transport into the vapor capillary in the case of active gases. In this process, the gases dissociate (if they are molecular gases) and ionize under the influence of the laser beam on entrance into the vapor capillary. On recombination of the gases, which takes place deeper in the capillary with a decline in the energy density, the ionization energy and the dissociation energy are released again. Since the process gas flows into the vapor capillary and the laser energy at the base of the capillary declines, recombination takes place closer to the base of the vapor capillary. The recombination energy is thus released at the location where material must be vaporized. The helium in the process gas ensures a uniform distribution of the active gases in the very fine capillary. This is necessary so that the energy transport takes place effectively due to this recombination and thus the reactions of the active gas also take place at all locations and there are no quality-reducing irregularities in the weld.

Carbon dioxide, oxygen, hydrogen, nitrogen or a mixture of these two gases is advantageously present as the active gas. These gases are characterized in that through chemical and physical reactions with the parent material, the latter can be influenced in a particularly advantageous manner. Furthermore, these molecular gases ensure effective energy transport into the vapor capillary.

In an advantageous embodiment of this invention, the process gas contains 0.01 vol % to 50 vol %, preferably 1 vol % to 30 vol %, especially preferably 5 vol % to 20 vol % active gas. Even at very low quantities in the vpm range, improvements in the appearance of the weld area manifested with certain materials such as aluminum and aluminum alloys, but negative effects which may occur with sensitive materials do not yet play a role here. In the case of larger-volume quantities, energy transport also plays a role. The upper limit is usually based on the negative effects of the active gases on the quality of the weld. However, another crucial factor may be the fact that the helium content cannot be reduced further without having a negative effect on quality or the welding process. Binary mixtures of active gases and helium and ternary mixtures of active gas, helium and argon are advantageous. In many cases, it is advantageous to use a mixture of different active gases instead of one active gas.

In another advantageous embodiment of this invention, helium is used as the process gas. When using pure helium (the usual impurities may certainly still be present in the helium) all have the abovementioned advantages based on helium.

The inventive method is advantageous with almost all materials. It is suitable for welding steels (unalloyed, low alloy and high alloy), stainless steel, corrosion-resistant steel, aluminum, aluminum alloys, copper-based materials and nickel-based materials.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-7. (canceled)

8. A method of laser beam welding using a fiber laser, comprising the steps of:
focusing a laser beam produced by the fiber laser at least one of on or near a machining site; and
directing a process gas containing helium at the machining site.

9. The method of claim 8, wherein the process gas contains 10 vol % to 90 vol % helium

10. The method of claim 8, wherein the process gas contains, 20 vol % to 70 vol % helium

11. The method of claim 8, wherein the process gas contains, 30 vol % to 50 vol % helium.

12. The method of claim 8, wherein the process gas contains argon.

13. The method of claim 9, wherein the process gas contains argon.

14. The method of claim 8, wherein the process gas contains an active gas.

15. The method of claim 9, wherein the process gas contains an active gas.

16. The method of claim 12, wherein the process gas contains an active gas.

17. The method of claim 14, wherein the active gas contains at least one of carbon dioxide, oxygen, hydrogen and nitrogen.

18. The method of claim 15, wherein the active gas contains at least one of carbon dioxide, oxygen, hydrogen and nitrogen.

19. The method of claim 16, wherein the active gas contains at least one of carbon dioxide, oxygen, hydrogen and nitrogen.

20. The method of claim 14, wherein the process gas contains 0.01 vol % to 50 vol % active gas.

21. The method of claim 14, wherein the process gas contains 1 vol % to 30 vol % active gas.

22. The method of claim 14, wherein the process gas contains 5 vol % to 20 vol % active gas.

23. The method of claim 15, wherein the process gas contains 0.01 vol % to 50 vol % active gas.

24. The method of claim 15, wherein the process gas contains 1 vol % to 30 vol % active gas.

25. The method of claim 15, wherein the process gas contains 5 vol % to 20 vol % active gas.

26. The method of claim 16, wherein the process gas contains 0.01 vol % to 50 vol % active gas.

27. The method of claim 16, wherein the process gas contains 1 vol % to 30 vol % active gas.

28. The method of claim 16, wherein the process gas contains 5 vol % to 20 vol % active gas.

29. The method of claim 8, wherein the process gas consists of helium.
